(19) United States
(12) Patent Application Publication
(10) Pub. No.: US 2026/0109537 A1
(43) Pub. Date: Apr. 23, 2026

(54) REFUSE BAG ROLL, REFUSE DISPOSAL SYSTEM, METHOD FOR DISPOSING OF REFUSE, AND METHOD FOR PROVIDING A REFUSE BAG ROLL

(71) Applicant: Marcus Trojan GmbH, Berlin (DE)

(72) Inventor: Marcus TROJAN, Berlin (DE)

(73) Assignee: Marcus Trojan GmbH, Berlin (DE)

(21) Appl. No.: 18/847,474

(22) PCT Filed: Mar. 12, 2024
(86) PCT No.: PCT/EP2024/056512

§ 371 Date: Sep. 16, 2024

(30) Foreign Application Priority Data
Jul. 11, 2023 (EP) 23184832.6

(51) Int. Cl. B65F 1/00; B65F 1/14

(52) U.S. Cl. CPC B65F 1/0053; B65F 1/0006; B65F 1/1484; B65F 2210/128; B65F 2250/00

(57) ABSTRACT

A refuse bag roll comprises a plurality of refuse bags (10^{IV}) which have at least two refuse bag areas (16^{IV}-1, 16^{IV}-2, 16^{IV}-3 and 16^{IV}-4), which may be filled from a common side (“filling opening”), and which are each separable from the refuse bag non-destructively, so that the refuse bag areas (16^{IV}-1, 16^{IV}-2, 16^{IV}-3 and 16^{IV}-4) each form separate refuse bags after separation from the refuse bag.

The invention relates to a refuse bag roll, a refuse disposal system, a method for disposing of refuse and a method for providing a refuse bag roll.

Refuse bag rolls are generally known as household goods. An individual refuse bag may be separated from the open end of a refuse bag roll by means of a perforation or other material weakening. This other material weakening may be a thinning of a plastics material, for example. Normally, an individual refuse bag is separated by hand. However, the material weakening may also make it possible to cut the bag off using a tool such as a knife or scissors.

Such refuse bag rolls are typically manufactured in such a way that the individual refuse bags are each produced separately and then folded into sheets. These sheets are in turn fed to a joining device via feed tracks, where the sheets are joined one at a time to one another. Welding is a particularly suitable joining technique, for example by melting (with application of heat) and/or pressure welding (with application of pressure). The material weakening, such as the aforementioned perforation, is then introduced into the joint. This creates an endless strip of refuse bags. A strip with the desired number of refuse bags for the refuse bag roll is cut from this and wound up. A paper roll or similar is then applied to the wound-up refuse bags to prevent them from unwinding independently. Other fixing options are also possible. The individual refuse bags may have a certain complexity, for example it is regularly provided that a drawstring is provided at the top of an opening of the refuse bag and is guided in a guide and/or loops in order to pull the refuse bag closed after it has been filled and to hold it in the closed state.

The individual refuse bags on a refuse bag roll typically lie transversely to the length of the refuse bag roll, so that the later opening side of the refuse bag points to one side and the underside of the refuse bag, which is closed, points to the other side. The material weakenings extending transversely in relation to the refuse bag roll therefore separate the individual refuse bags on their long side. In principle, however, it is also possible to form refuse bag rolls in which the individual refuse bags are offset by 90°, that is to say in which the side of the refuse bag to be opened later is the side on which the material weakenings for separating the individual refuse bags are provided.

All of the above with regard to refuse bag rolls and refuse bags may be realized within the scope of the invention and in particular in embodiments.

DE 20 2021 103 927 U1 discloses a refuse bag roll which has film parts in several colours to enable a user to mark the filled refuse bags by colour and thus make it easier for the refuse disposal company to sort the refuse.

CN 107792564 A describes a refuse bag with a centre partition to form two container areas.

A refuse bag with two compartments is known from the CN 205312322 U.

It is the object of the present invention to promote waste separation and to provide improved refuse bags, refuse bag rolls, a refuse disposal system and a method for disposing of refuse.

The object is achieved by a refuse bag roll having the features according to claim 1, by a method for disposing of refuse having the features according to claim 13, and by a method for providing a refuse bag roll according to claim 14.

The refuse bag roll according to the invention thus comprises a plurality of refuse bags rolled up one after the other, which are separable from one another by material weakenings running in the transverse direction of the refuse bag roll. Here, each of the refuse bags has at least one filling opening for refuse and at least two refuse bag areas, which are fillable via the at least one filling opening. The refuse bag areas are each separable from the refuse bag non-destructively, so that the refuse bag areas form separate refuse bags after separation from the refuse bag.

The invention thus introduces a refuse bag as part of a refuse bag roll which, with several refuse bag areas, enables the separation of the refuse/waste already when filling the refuse bag. This means that the user does not need to have several individual bins with respective refuse bags, but may instead transfer one refuse bag from the refuse bag roll to a bin and sort different types of waste within the refuse bag. The option of separating the refuse bag areas to form individual, separate refuse bags means that the sorted waste collected may be disposed of separately according to sorting group. The fact that the refuse bag has at least two refuse bag areas may include that it has exactly two refuse bag areas or at least three refuse bag areas, the latter may include exactly three refuse bag areas or at least four refuse bag areas, the latter may include exactly four refuse bag areas or at least five refuse bag areas, the latter may include exactly five refuse bag areas or at least six refuse bag areas, of which again the latter may comprise exactly six refuse bag areas or at least seven refuse bag areas, of which again the latter may comprise exactly seven refuse bag areas or at least eight refuse bag areas, of which again the latter may comprise exactly eight refuse bag areas or at least nine refuse bag areas, of which again the latter may comprise exactly nine refuse bag areas or at least ten refuse bag areas, and so on.

According to advantageous embodiments of the invention, each refuse bag has a main bag wall and, provided on the main bag wall, at least one connecting wall, by means of which refuse bag areas are formed. The connecting walls run at least in sections in the longitudinal direction, thus enabling the insertion of refuse at a filling depth corresponding to the longitudinal direction, and a material weakening for non-destructive separation is formed at the connecting areas.

Advantages of this embodiment may be that a normal film may be provided as the main bag wall during manufacture, in particular also in the form of an individual bag, and the connecting walls may be attached subsequently (welded on, by means of welding with the application of heat and/or with the application of pressure).

According to one aspect, it may be provided that the main bag wall is an outer wall and the connecting wall has two layers (“double bag wall”), one of which, after separation, belongs to a first separate refuse bag and another of which belongs to a second separate refuse bag.

The advantages of these embodiments are that the refuse bag may be easily separable into several smaller refuse bag areas.

According to an alternative aspect, it is provided that all connecting walls are provided next to each other on one side of the main bag wall. This embodiment may be advantageous in terms of production, in particular it may be produced easily and therefore inexpensively.

According to other embodiments of the invention, each refuse bag may comprise a plurality of individual bags providing the refuse bag areas, wherein the individual bags are attached on one side to a common strip (preferably in the manner of a fold).

In this case, the individual bags are arranged like a booklet and are particularly preferably open on a side opposite the strip so that the individual bags may fan out. If necessary, a suitable bin may be provided for this purpose, in which only the strip needs to be attached and the individual bags may then be fanned out.

According to embodiments, the material weakenings are formed on the strip. The individual bags may be manufactured separately and welded together on the strip (application of heat and/or pressure), and at the same time the material weakening may be provided (e.g. by punching).

According to embodiments of the invention, the refuse bag areas of the refuse bags are configured differently.

On the one hand, at least two refuse bag areas may be designed in different sizes, in particular to take account of the fact that different types of refuse to be filled in, which are to be separated from each other, do not occur in equal quantities per type.

Alternatively or additionally, it is provided that at least two refuse bag areas of each refuse bag have different colours. Marking the individual refuse bag areas in different colours makes it easier for the user to separate the refuse. For example, the colour blue may stand for paper refuse, the colour brown for organic refuse, the colour yellow for plastic refuse, etc. If necessary, labelling may also be provided as an alternative or in addition.

According to another preferred embodiment with differently formed refuse bag areas, at least two refuse bag areas of each refuse bag are made of different materials. This may depend on the refuse to be disposed of. The materials may include at least two of plastic film, recycled plastic, compostable plastic, aluminium, paper, cellulose and hemp. The compostable plastic and/or hemp may be favourable for organic refuse, whereas it is not critical if plastic refuse, for its part, is provided in plastic film or recycled plastic. For paper refuse, the refuse bag area may be made of paper. An individual refuse bag area may also be made of different materials. For example, the refuse bag area for organic refuse may consist of or include compostable plastic in combination with a paper reinforcement. The optional drawstring may be made of a different material for refuse bag areas than the rest of the refuse bag area in question.

According to preferred embodiments of the invention, more types of refuse bags are provided in the refuse bag roll. There is thus at least one refuse bag that differs from other refuse bags. This aspect may also be regarded as an invention in itself, independently of the provision of the refuse bag areas, i.e. the invention described so far. In this aspect, first one type of refuse bag may be separated from the refuse bag roll and then another type of refuse bag. For example, one type of refuse bag may have several refuse bag areas, one of which is suitable for paper refuse and one for organic refuse; this may be accommodated in an organic refuse bin. Another refuse bag may be provided for plastic refuse, in which a special compartment (separate refuse bag area) is provided for glass.

According to other embodiments of the invention, the refuse bag areas are provided by individual bags which are connected to a material protrusion at least in one region on a side adjacent to the filling opening. In this case, the individual bags are arranged concentrically around the material protrusion and, particularly preferably, each individual bag has a filling opening, all of which are located on a side that is adjacent to the side that is connected to the material protrusion. Depending on the number, the individual bags could be fanned out in the shape of a multi-pronged star, i.e. a three-pronged star, a four-pronged star or a cross, a five-pronged star, etc. In this way, the individual bags could utilize the space around the material protrusion particularly efficiently. Once the individual bags have been fanned out, they are particularly easy to fill individually and then separate from the excess material non-destructively.

The connection to the material protrusion could have a material weakening, e.g. a perforation, with the help of which the individual bags may be easily separated. To further facilitate separation, it is also conceivable that the connection to the material protrusion only exists over a small region of the longitudinal axis. For example, the individual bags might be connected to the material protrusion only in one third, e.g. the centre third, of the longitudinal axis. If the individual bags are equipped with a drawstring, it would be possible, for example, to separate them by simply actuating the drawstring.

According to embodiments, it is provided that at least one of the individual bags has a folded bottom or a cross bottom on the side opposite the filling opening. This could increase the integral stability of the fanned-out refuse bag and allow it to stand upright on its own without additional fastening.

According to further embodiments in this regard, it is provided that, in the rolled-up form of the refuse bag roll, the outer and/or the inner individual bag has a connecting element which is configured to be able to detachably connect the outer and the inner individual bag to one another. In particular, one of the two individual bags has an adhesive surface, especially one with a removable protective layer. Instead of the adhesive surface, co-operating connecting elements such as hooks and eyelets made of refuse bag material on the two individual bags or loops or protrusions that may be knotted together are also conceivable. This could increase the stability of the refuse bag when fanned out by connecting the two individual bags that are directly next to each other after fanning out, thus preventing the fanned-out star from collapsing.

According to further embodiments, it is provided that at least one of the individual bags has a hole or a fastening element, in particular an adhesive surface or a loop, on the side opposite the connection to the material protrusion. In this way, the individual bags could be attached to the walls or corners of a container, for example, to further stabilize the star shape.

According to further embodiments, it is provided that the material protrusion on the side of the filling openings has a gripping element, in particular a loop. This makes it particularly easy to move all the individual bags at the same time, e.g. to remove them from a container.

According to other embodiments of the invention, at least one refuse bag and/or at least one refuse bag area has a device-readable information carrier, wherein the information carrier is in particular a QR code. Alternatively, the information carrier could also be a bar-code or an NFC tag, for example. This would allow information regarding the use of refuse bags or individual bin areas to be stored individually.

According to embodiments, it is provided that the information carrier is configured to be able to cause a device reading the information carrier to output text information and/or to install or execute a software and/or to call up a website, or combinations thereof. In this case, the information carrier would have machine-readable instructions that may be executed on the device reading the information carrier, wherein information on refuse disposal could be received by the reading device and displayed by it. For example, such an information carrier could be in the form of a QR code and, by executing the machine-readable instructions, could cause the device reading the QR code to display a text stored in the QR code that contains information on the use of the refuse bags or, for example, on refuse disposal. In this way, the refuse bag/refuse bag area could facilitate access to information on its use for a large number of users.

Instead of a text stored in the QR code, it would also be conceivable that the machine-readable instructions first cause the device to receive a corresponding text via an Internet connection and to then output it. It would also be conceivable for the machine-readable instructions to first prompt the device to install software or to execute it if it has already been installed correspondingly. The software could then provide the user with information on the use of refuse bags or, for example, refuse disposal. The same applies to calling up a website that the machine-readable instructions prompt the device to access. The website could be used to provide the user with the relevant information.

The refuse disposal system according to the invention comprises a refuse bag roll, in which at least one refuse bag and/or at least one refuse bag area has a device-readable information carrier, and a portable electronic communication device, in particular a smartphone. The electronic communication device has means for reading the information carrier and means for outputting information. The electronic communication device is configured to be prompted, by reading the information carrier, to output text information and/or to install or execute software and/or call up a website. In this way, information regarding the use of the refuse bags could be made available to the user in a particularly simple and detailed manner, as smartphones with means for reading information carriers, e.g. NFC readers or cameras for capturing QR codes, are particularly widespread and typically have an Internet connection and a display, which makes it easier overall to provide the user with particularly up-to-date and detailed information regarding the use of the refuse bags. According to embodiments, it is provided that by outputting the text information and/or executing the software and/or calling up the website, information on regulations on refuse disposal and/or information on refuse collection is output. This would make it easier to dispose of refuse in accordance with the applicable regulations and to collect refuse, as the relevant information could be made available to users reliably and repeatedly. For example, text information could be displayed to inform the user about the type of refuse areas or refuse bags for which individual refuse areas or refuse bags are intended and how or at what times the corresponding bags are collected or what costs are associated with disposal.

As the information available to the user could be stored individually, country- or region-specific information would also be possible, for example, as different countries/regions have different regulations regarding refuse disposal or different colour codes are used for the refuse bags of different types of waste. It is also conceivable that individual information could be provided for areas that are more restricted in terms of space, such as campsites or event sites, so that the information issued could be specific to this area. For example, a separate colour coding scheme could be defined for a campsite, e.g. blue for refuse paper, black for residual waste and green for organic waste. The collection times for the individual types of waste could be stored as information, along with a description of the items with which the respective bags may be filled. This text information could thus be retrieved particularly easily and repeatedly by people using the campsite.

If reading the information carrier causes the smartphone to install software, execute installed software or call up a website, the stored information could be individualized and kept up to date particularly easily, as the software or website itself could be adapted and the adapted information could be called up by reading the same information carrier.

According to further embodiments, it is provided that the portable electronic communication device has means for determining a device location and is configured to determine the device location before outputting the regulations for refuse disposal and/or the instructions for refuse collection and to be able to output the instructions for regulations for refuse disposal and/or the instructions for refuse collection depending on the determined device location. In this way, the user could be provided with country- or region-specific information on refuse disposal regulations and/or information on refuse collection based on the device location.

According to further embodiments, it is provided that the calling up of the website and/or the execution of the software initiated by reading the information carrier also comprises the entry of a value in a database. The value to be entered is linked here to the refuse bag/refuse bag area, for example. The database could be a central database outside the smartphone that the smartphone may access. A database within the software installed on the user's smartphone would also be conceivable. It is conceivable that values in the database could be used to generate statistics for the party that issues, produces or collects the refuse bags, e.g. how many bags of a certain type have already been used or disposed of. Based on such statistics, the design of the refuse bags could be optimized, for example by increasing the number of frequently used bags or enlarging these bags.

It is also conceivable that such a value could be used to enable payment transactions, e.g. for the purchase of individual refuse bags or a refuse bag roll or the disposal of individual refuse bags. A user account could be provided for this purpose, which the software or website could make available. This user account could be linked to the database. It would also be conceivable that the payment process for future refuse bags could be realized with the help of such a user account.

In this context, it is conceivable to provide the user with a refuse bag roll of which the bags and refuse bag areas are labelled with QR codes that are linked to the user's account from the outset. In this case, for example, the user could scan the QR codes of the individual refuse bag areas, e.g. before they are disposed of and thus create an entry in the database. The database could be a central database that is linked to the user account. A database within software installed on the user's smartphone and linked to the user account would also be conceivable. The values in the database could, for example, be used for individualized billing if, for example, the disposal of different refuse bags costs different amounts.

This would allow billing to be based on the actual use of the individual refuse bag areas. For example, discounts for the use of certain refuse bags, e.g. for organic waste, could be offset against the costs for the use of other refuse bags, e.g. for residual waste. Instead of the bags and refuse bag areas with QR codes, which are linked to the user account of the user from the outset, it would also be conceivable that each individual refuse bag roll or each individual refuse bag has an individual QR code and by scanning such an individual QR code with the smartphone, the corresponding refuse bag roll/refuse bag is linked to a user account, usually to the user account of the smartphone that captures the QR code.

For example, the information carrier could be read by the user themself or by persons who come into contact with the bag to be disposed of, e.g. when receiving refuse bags at a campsite or event site. Instead of manual reading by such persons, the information carrier could also be read (semi-)automatically, for example by refuse transporters or refuse collection containers, each of which is equipped with a corresponding reader. In principle, such refuse collection containers could be imagined as being similar to an oversized deposit machine or even a self-service checkout with an attached refuse disposal container.

The entries in the database could be used to generate statistics, e.g. how many bags of a certain type the user has already used or disposed of and how their waste quantities or compliance with refuse disposal regulations compare to other users or the total number of users, which in turn could change the payment transactions or the amounts on which the payment transactions are based, e.g. through discounts or bonus points. It is conceivable that the user could receive discounts for future payment transactions or bonus points if they fulfil certain criteria, such as using or disposing of several refuse bags of one type. The individual use or disposal processes could be recorded, for example, by reading the information carrier or by manual entry by the user or a person receiving the refuse bag.

According to further embodiments, it is provided that calling up the website and/or executing the software also comprises executing a refuse disposal analysis application, wherein the refuse disposal analysis application is configured to be able to analyze the disposal of the refuse, in particular on the basis of user information or the entries in the database, depending on the regulations for refuse disposal. In this way, the analysis of waste quantities and disposal behaviour could be carried out particularly efficiently, as the disposal analysis could be triggered by the user and the resources of the smartphone could be used for the calculation. It is also conceivable that the disposal analysis takes into account device location data that was recorded by reading the information carrier when user details or values were entered in the database. This in turn would allow the refuse disposal analysis to be carried out with particular precision, i.e. in relation to the applicable regulations, as different refuse disposal regulations in different regions could be taken into account.

According to further embodiments, it is provided that calling up the website and/or executing the software also comprises executing a visual identification application, wherein the visual identification application is configured to be able to identify refuse items located on visual images. Identification could be carried out using image recognition algorithms or machine learning, for example. In this way, the user who visually captures waste objects, for example by photographing them with a smartphone, could be provided with targeted information on regulations for the disposal of the object. For example, a user who takes a photo of an aluminium drinks can could be provided with information on which refuse bag is intended for the can, when and where the bag may be collected, and the associated costs. Discounts or bonus points could also be awarded depending on the results of the identification processes. Instead of image recognition algorithms or machine learning, it would also be conceivable for the visual identification application to recognize the item using a bar-code attached to it and determine the packaging material by comparing it with another database accessed by the software or the website, so that the packaging material may be used to determine which bag is intended for the item.

According to further embodiments, it is envisaged that the disposal of the refuse is alternatively or additionally analyzed on the basis of the identified refuse items. For example, the results of the identification processes could be used by the disposal analysis application. This could increase the quality of the data obtained using the disposal analysis application, as visual identification could compensate for incorrect user information.

The method for disposing of refuse according to the invention comprises:
providing a refuse bag having at least two compartments,
filling at least one of the compartments,
separating the filled compartment from the rest of the refuse bag,
transferring the filled compartment to a refuse bin/refuse container.

The separation of the filled compartment may be accompanied by the fact that a single additional compartment remains, which in turn has been filled and is moved to another type of refuse bin. However, separating the filled compartment may also mean that the remaining refuse bag remains for further filling. Preferably, differently filled compartments are filled with different types of refuse for the purpose of waste separation.

According to one embodiment, the following additional steps are provided:
providing a refuse disposal system according to the invention and
reading out the information carrier.
   In addition, the filled compartment is fed to a refuse disposal system depending on the regulations for refuse disposal and/or the instructions for refuse collection.

On the one hand, this could ensure that the user receives the relevant information on the regulations for refuse disposal or refuse collection in order to be able to fill the compartment in accordance with the regulations. On the other hand, by making the supply of refuse for disposal dependent on these regulations, it could be ensured that the disposal itself also complies with the regulations and thus the efficiency of refuse disposal could be increased.

The advantages of the methods result from the aforementioned advantages of the respective refuse bag rolls according to the invention.

The method according to the invention for providing a refuse bag roll of the type according to the invention comprises the fact that a user group and/or a usage period is (or are) determined, wherein for the user group and/or the usage period it is estimated on the basis of measurements which types of refuse occur in which quantities and a manufacturing instruction for a refuse bag roll is specified from at least two manufacturing instructions for different refuse bag rolls, each according to the type according to the invention, in such a way that the refuse bag areas of the refuse bags have colours and/or dimensions matching the estimated quantities. The method ends with the production of the refuse bag roll according to the specified manufacturing instructions. For example, a different refuse bag roll may be provided for a “private household with adults” user group than for a “private household with small children” user group, where the refuse bag roll must have a larger refuse bag area for residual waste (nappies). A distinction may also be made between a private household and a hotel as a user group, wherein a hotel is not typically expected to have a large amount of organic refuse, but more paper refuse. For example, in a refuse bag for hotels, a refuse bag area for organic refuse may be dispensed with completely and this refuse may be allocated to residual waste if necessary; refuse bag areas for plastic and glass may be combined into one refuse bag area, and the like. The utilization period may also determine which types of refuse occur and in which quantities. For example, more organic refuse may be expected in summer because more and/or better fruit is available, fresh vegetables are cooked more often, and the like.

The invention is described in greater detail below with reference to the drawing, in which

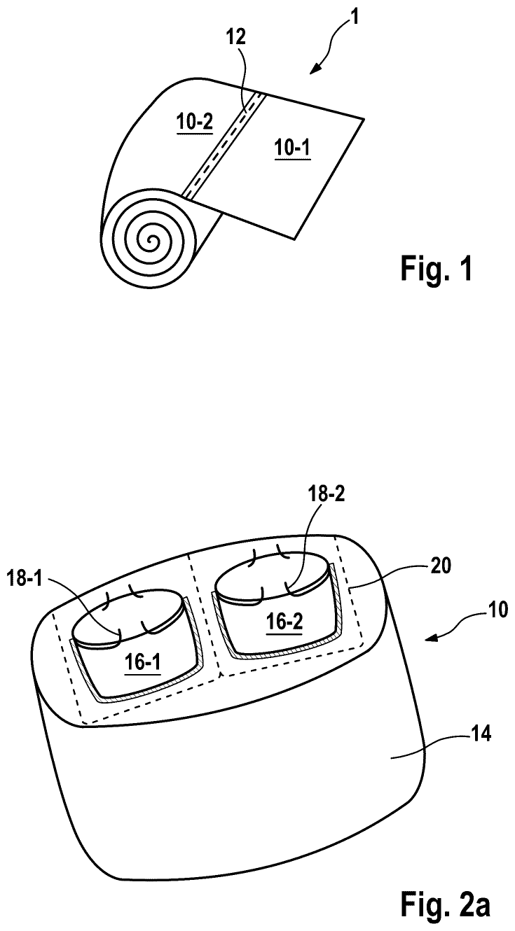

FIG. 1 schematically shows a refuse bag roll as a whole;

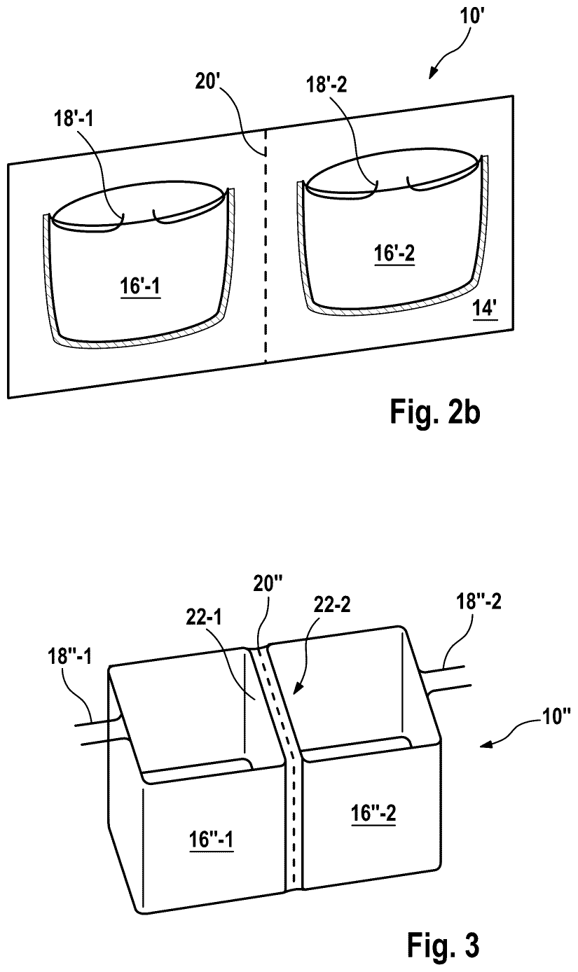

FIG. 2a shows a first variant of a first embodiment of a refuse bag, which may be provided by the refuse bag roll,

FIG. 2b shows a second variant of the first embodiment of a refuse bag, which may be provided by the refuse bag roll;

FIG. 3 illustrates a second embodiment of a refuse bag;

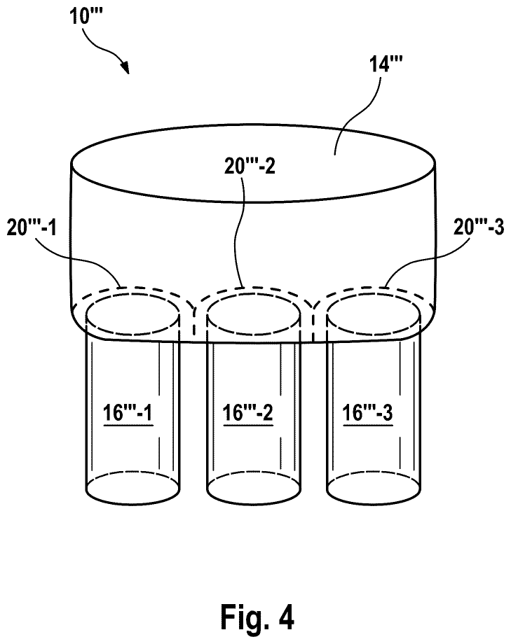

FIG. 4 illustrates a third embodiment of a refuse bag; and

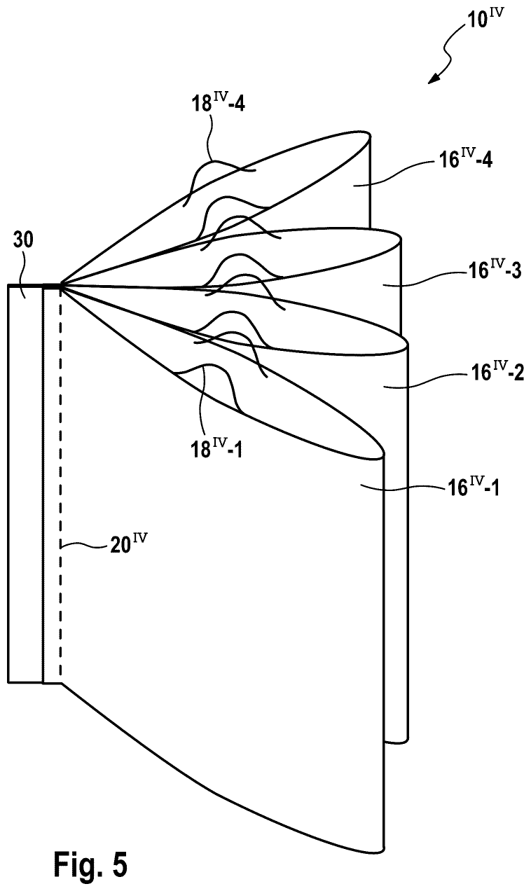

FIG. 5 illustrates a fourth embodiment of a refuse bag; and

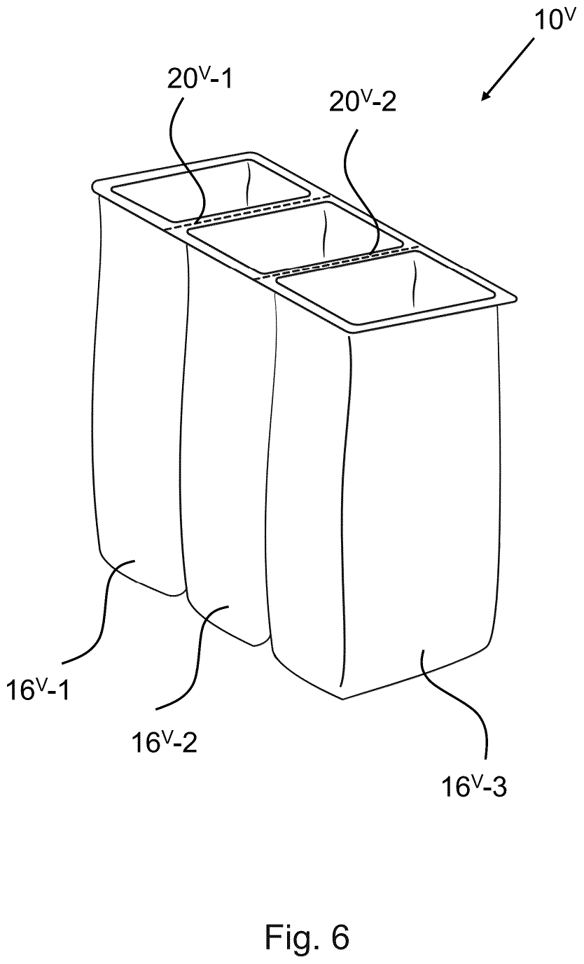

FIG. 6 illustrates a fifth embodiment of a refuse bag; and

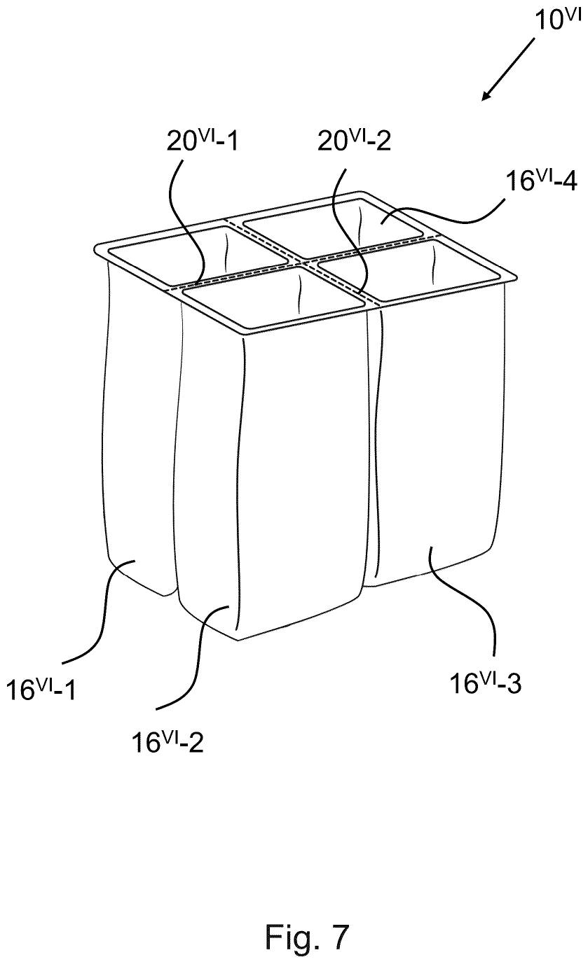

FIG. 7 illustrates a second variant of the fifth embodiment of the refuse bag; and

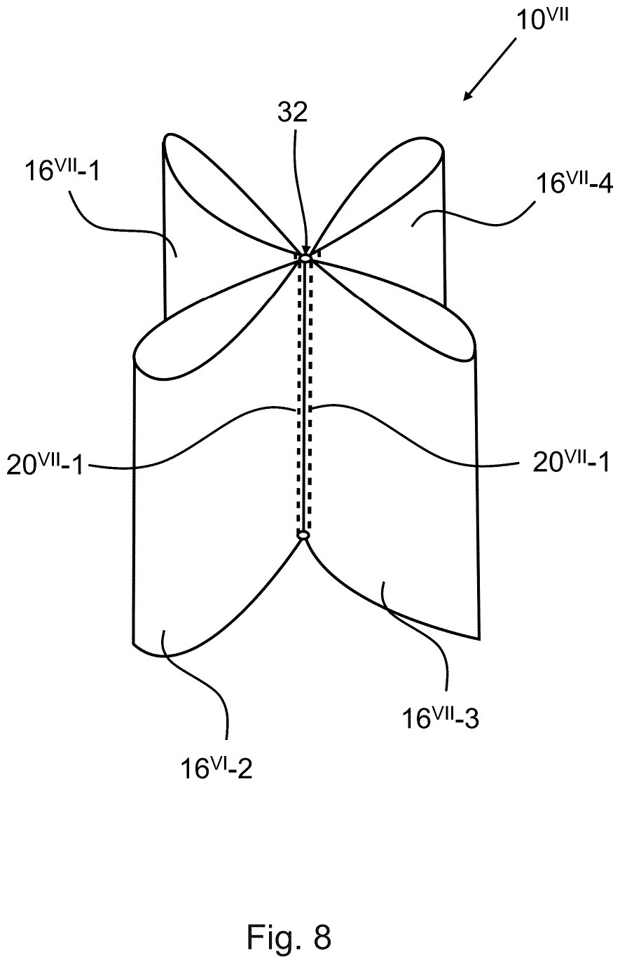

FIG. 8 illustrates a sixth embodiment of a refuse bag.

A refuse bag roll designated as a whole by 1 consists of a plurality of refuse bags 10-1, 10-2 etc. rolled up one after the other, which are separable from one another by material weakenings 12 running in the transverse direction of the refuse bag roll, for example in the form of perforations. Typically, the first refuse bag 10-1 is separated from the second refuse bag 10-2 and used, while the remaining refuse bag roll is kept as stock. The embodiments of refuse bags 10, 10′, 10″, 10′″, 10^{IV} shown below may in principle be provided individually, but are preferably provided by a refuse bag roll of the type of refuse bag roll 1 shown in FIG. 1.

FIG. 2a shows a first variant of a first embodiment of the invention as refuse bag 10; FIG. 2b shows a second variant of this embodiment as refuse bag 10′.

In the refuse bag 10, an outer wall 14 is closed and forms a refuse bag in itself, wherein refuse bag areas 16-1, 16-2 are preferably formed on the inner side of the outer wall, preferably by welding on a connecting wall, wherein the rear side of the respective refuse bags is provided by the outer wall 14, and wherein the individual refuse bag areas are separable from the rest of the refuse bag due to perforations 20. Optionally provided drawstrings 18-1 on the first refuse bag area 16-1 and 18-2 on the second refuse bag area 16-2 are guided by loops, wherein the loops extend on the connecting wall and also on the inner side of the outer wall 14.

In the refuse bag 10′ shown in FIG. 2b according to the second variant of the first embodiment, an open wall is provided as the main bag wall 14′, on which the connecting walls for forming the refuse bag areas 16′-1 and 16′-2 are arranged. Due to the perforation 20′, the main bag wall 10′ may be divided into two parts, each with a refuse bag area, and each part may then be used as a separate refuse bag, in particular disposed of after filling. Optional drawstrings 18′-1 and 18′-2 are also provided here.

In the refuse bag 10″ shown in FIG. 3 according to a second embodiment of the invention, two refuse bag areas 16″-1 and 16″-2 are formed next to each other and each region is provided by a common bag, wherein as connecting walls 22-1 and 22-2 two neighbouring (double) layers are provided which may be separated from one another by a perforation 20″, so as to form separate refuse bags which each have a drawstring 18″-1 and 18″-2 respectively. In this case, the main bag wall is the outer wall of the entire refuse bag 10″, which is not provided with a reference sign in FIG. 3.

In the refuse bag 10′″ shown in FIG. 4 according to a third embodiment, the main bag wall 14′″ is a bag which is open at the top in FIG. 4 and to which the further refuse bag areas 16′″-1, 16′″-2 and 16′″-3 are attached, wherein they are separable at the perforations 20′″-1, 20′″-2 and 20′″-3. In principle, this is designed like a glove with detachable fingers. Drawstrings may also be provided here, but these are not shown in FIG. 4.

In the refuse bag 10^{IV} shown in FIG. 5 according to the fourth embodiment of the invention, a plurality of refuse bag areas 16^{IV}-1, 16^{IV}-2, 16^{IV}-3 and 16^{IV}-4 are provided, which are welded together on a strip 30 in the manner of a fold, wherein a preferably single perforation 20^{IV} is formed on the strip. If the strip 30 is torn off, the refuse bag 10^{IV} is divided into the plurality of refuse bag areas 16^{IV}-1, 16^{IV}-2, 16^{IV}-3 and 16^{IV}-4 Each refuse bag area 16^{IV}-1, 16^{IV}-2, 16^{IV}-3 and 16^{IV}-4 has a drawstring; the drawstrings 18^{IV}-1 and 18^{IV}-4 are labelled here as examples. In this embodiment, the individual refuse bag areas 16^{IV}-1 to 16^{IV}-4 may be made particularly well from different materials, for example for paper refuse from paper, for organic refuse from compostable material, in particular compostable plastic, for plastic from plastic film, and for glass from recycled plastic or also aluminium with somewhat thicker and more stable walls.

In the refuse bag 10^{V} shown in FIG. 6 according to a fifth embodiment of the invention, a plurality of refuse bag areas 16^{V}-1, 16^{V}-2, 16^{V}-3 is provided, in which at least one side of the filling opening of a refuse bag area 16^{V}-1, 16^{V}-2, 16^{V}-3 is connected to one side of the filling opening of another refuse bag area 16^{V}-1, 16^{V}-2, 16^{V}-3, wherein the refuse bag areas 16^{V}-1, 16^{V}-2, 16^{V}-3 are separable at the perforations 20^{V}-1 and 20^{V}-2.

In the variant shown in FIG. 7 according to a fifth embodiment of the invention, a refuse bag 10^{VI} is provided with a plurality of refuse bag areas 16^{VI}-1, 16^{VI}-2, 16^{VI}-3 and 16^{VI}-4 are provided, in which two sides of the filling opening of a refuse bag area 16^{VI}-1, 16^{VI}-2, 16^{VI}-3 and 16^{VI}-4 are each connected to one side of the filling opening of another refuse bag area 16^{VI}-1, 16^{VI}-2, 16^{VI}-3 and 16^{VI}-4. The refuse bag areas 16^{VI}-1, 16^{VI}-2, 16^{VI}-3 and 16^{VI}-4 are separable at the perforations 20^{VI}-1 and 20^{VI}-2.

In the refuse bag 10^{VII} shown in FIG. 8 according to a sixth embodiment of the invention, a plurality of individual bags 16^{VII}-1, 16^{VII}-2, 16^{VII}-3 and 16^{VII}-4 are provided, which are connected over their full length to a material projection 32 on a side adjacent to the filling opening, wherein the individual bags 16^{VII}-1 and 16^{VII}-2 are separable from the material protrusion 32 at the perforations 20^{VII}-1, 20^{VII}-2. A connection with the material protrusion 32 over a smaller area, e.g. only in the centre third, is also conceivable. The individual bags 16^{VII}-3 and 16^{VII}-4 are separable from the material protrusion 32 at perforations not provided with reference signs in FIG. 8. The individual bags 16^{VII}-1 to 16^{VII}-4 may be fanned out in this embodiment in the shape of a four-pronged star or a cross. Preferably, the individual bags 16^{VII}-1 to 16^{VII}-4 each have a folded bottom or a cross bottom on the side opposite the filling opening. In this way, the integral stability of the fanned-out refuse bag 10^{VII} could be increased and the refuse bag 10^{VII} could stand upright on its own.

In all of the above embodiments, it may be provided that the size and/or purpose of the refuse bag areas is varied, the latter possibly by colouring and/or labelling. In this way, it is possible to determine which types of refuse occur in a particular user group and in what proportions, and the size ratios for the refuse bag areas may be planned accordingly and some refuse bag areas may be omitted altogether.

The embodiments according to FIGS. 2a, 4 and 5 may be realized with fewer refuse bag areas than shown, and the embodiments according to FIGS. 2a, 2b, 3, 4 and 5 may also be realized with more refuse bag areas than shown.

A “smartphone”, as used here, is to be understood without limitation of generality as meaning that the term “smartphone” includes all electronic communication devices such as smartwatches or tablets.

A “QR code”, as used here, is to be understood without limitation of generality as meaning that the term “QR code” includes all information carriers such as barcodes or NFC tags. The phrases “scanning a QR code”/“capturing a QR code” are also generally understood to mean reading an information carrier.

The terms “refuse” and “waste” are to be understood as synonymous in the context of this application.

### List of Reference Signs

1 refuse bag roll
10 refuse bag
10-1, 10-2 refuse bags rolled up one after the other
10′, 10″, 10′″, 10^{IV} embodiments of refuse bags
12 material weakening
14 outer wall
14″′ main bag wall
16-1, 16-2 refuse bag areas
16′-1, 16′-2 refuse bag areas
16″-1, 16″-2 refuse bag areas
16′″-1, 16′″-2, 16″′-3 refuse bag areas
16^{IV}-1, 16^{IV}-2, 16^{IV}-3, 16^{IV}-4 refuse bag areas
16^{V}-1, 16^{V}-2, 16^{V}-3 refuse bag areas
16^{VI}-1, 16^{VI}-2, 16^{VI}-3, 16^{VI}-4 refuse bag areas
16^{VII}-1, 16^{VII}-2, 16^{VII}-3, 16^{VII}-4 refuse bag areas
18-1, 18-2 drawstrings
18′-1, 18′-2 drawstrings
18″-1, 18″-2 drawstrings
18^{IV}-1, 18^{IV}-4 drawstrings
20, 20′, 20″, 20″′-1, 20′″-2, 20″′-3, 20^{IV} perforations
20^{V}-1, 20^{V}-2, 20^{VI}-1, 20^{VI}-2, 20^{VII}-1, 20^{VII}-2 perforations
22, 1, 22-2 connecting walls
30 strip
32 material protrusion

1-49. (canceled)

50. A refuse bag with at least one filling opening for refuse and at least two refuse bag areas (16-1, 16-2; 16′-1, 16′-2; 16″-1, 16″-2; 16″′-1, 16″′-2, 16″′-3), which are fillable via the at least one filling opening for the at least two refuse bag areas, wherein the refuse bag areas (16-1, 16-2; 16′-1, 16′-2; 16″-1, 16″-2; 16″′-1, 16″′-2, 16″′-3) are each separable from the refuse bag non-destructively, so that the refuse bag areas (16-1, 16-2; 16′-1, 16′-2; 16″-1, 16″-2; 16″′-1, 16″′-2, 16″′-3) form separate refuse bags after separation from the refuse bag, wherein each refuse bag (10, 10″) has a main bag wall (14, 14′) on which at least one connecting wall (22-1, 22-2) is provided, by means of which refuse bag areas (16-1, 16-2; 16′-1, 16′-2; 16″-1, 16″-2) are formed, wherein the at least one connecting wall extends at least in sections in the longitudinal direction, and wherein a material weakening (20, 20′, 20″) for non-destructive separation is formed on the at least one connecting wall.

51. The refuse bag according to claim 50, wherein the main bag wall is an outer wall and the connecting wall comprises two layers (22-1, 22-2), one of which, after separation, belongs to a first separate refuse bag and another of which belongs to a second separate refuse bag.

52. The refuse bag according to claim 51, wherein all connecting walls are provided side by side on one side of the main bag wall (14′).

53. The refuse bag according to claim 50, wherein the refuse bag areas are formed differently.

54. The refuse bag according to claim 50, wherein at least two refuse bag areas are provided in different sizes.

55. The refuse bag according to claim 50, wherein at least two refuse bag areas are provided in different colours.

56. The refuse bag according to claim 50, wherein at least two refuse bag areas comprise different materials, in particular the different materials comprise at least two of plastic film, recycled plastic, compostable plastic, aluminium, paper, cellulose and hemp.

57. The refuse bag according to claim 50, wherein the refuse bag (10^{V}) comprises a plurality of individual bags (16^{VII}-1, 16^{VII}-2, 16^{VII}-3, 16^{VII}-4), which provide the refuse bag areas, wherein the individual bags are connected to a material projection (32) at least in a region on a side adjacent to the filling opening.

58. The refuse bag according to claim 54, wherein at least one of the at least two refuse bag areas has a folded bottom or a cross bottom on the side opposite the filling opening.

59. The refuse bag according to claim 56, wherein a first one of the at least two refuse bag areas comprises a connecting element which is configured to be able to releasably connect the first one of the at least two refuse bag areas to a second one of the at least two refuse bag areas, in particular the first one of the at least two refuse bag areas comprises an adhesive surface, in particular wherein the adhesive surface is provided with a removable protective layer.

60. The refuse bag according to claim 50, wherein at least one refuse bag area comprises a machine-readable information carrier, wherein the information carrier is in particular a QR code.

61. The refuse bag according to claim 59, wherein the information carrier is configured to be able to cause a device reading the information carrier to output text information, to install or execute a software, to call up a website, or to execute combinations thereof.

62. A refuse disposal system comprising a refuse bag according to claim 60 and a portable electronic communication device, in particular a smartphone, wherein the portable electronic communication device comprises means for reading the information carrier and means for outputting information, and wherein the portable electronic communication device is configured to be caused, by reading the information carrier, to output text information and/or to install or execute a software and/or to call up a website.

63. The refuse disposal system according to claim 62, wherein by outputting the text information and/or executing the software and/or calling up the website, information on regulations on refuse disposal and/or information on refuse collection is output.

64. The refuse disposal system according to claim 62, wherein the portable electronic communication device has means for determining a device location and is configured to determine the device location before outputting the regulations for refuse disposal and/or the instructions for refuse collection and to be able to output the instructions for regulations for refuse disposal and/or the instructions for refuse collection depending on the determined device location.

65. The refuse disposal system according to claim 62, wherein the calling up of the website and/or the execution of the software caused by reading the information carrier also comprises the entry of a value in a database.

66. The refuse disposal system according to claim 62, wherein the portable electronic communication device is configured to carry out a payment transaction via the software and/or the website in response to reading the information carrier, in particular using a user account associated with the user.

67. The refuse disposal system according to claim 62, wherein calling up the website and/or executing the software also comprises executing a refuse disposal analysis application, wherein the refuse disposal analysis application is configured to be able to analyze the disposal of the refuse, in particular on the basis of user information or the entries in the database, depending on the regulations for refuse disposal, in particular the disposal of the refuse is alternatively or additionally analyzed using the identified refuse items.

68. The refuse disposal system according to claim 62, wherein calling up the website and/or executing the software also comprises executing a visual identification application, wherein the visual identification application is configured to be able to identify refuse items located on visual images.

69. A refuse bag roll with a plurality of refuse bags according to claim 50, wherein the refuse bags are rolled up one after the other and are separable from one another by material weakenings extending in the transverse direction of the refuse bag roll, in particular wherein the refuse bags lie in the refuse bag roll transversely to the longitudinal extension thereof, so that the filling openings points to one side.
